(19) United States
(12) Patent Application Publication
(10) Pub. No.: US 2025/0147750 A1
(43) Pub. Date: May 8, 2025

(54) PROJECTOR SYSTEM, FIRMWARE UPDATE METHOD, AND PROJECTOR

(71) Applicant: Coretronic Corporation, Hsin-Chu (TW)

(72) Inventors: Wei-Chia Lu, Hsin-Chu (TW); Han-Chung Tseng, Hsin-Chu (TW)

(73) Assignee: Coretronic Corporation, Hsin-Chu (TW)

(21) Appl. No.: 18/931,104

(22) Filed: Oct. 30, 2024

(30) Foreign Application Priority Data
Nov. 6, 2023 (CN) 202311464381.4

(51) Int. Cl. G06F 8/65; H04L 67/00

(52) U.S. Cl. CPC G06F 8/65; H04L 67/34

(57) ABSTRACT

A projector system, including a first projector and at least one second projector, is provided. The first projector broadcasts first data to each of the at least one second projector in response to a first input operation applied to a first input/output unit. A second processor of each of the at least one second projector broadcasts corresponding second data to other projectors among multiple projectors in response to receiving the first data. Each of the projectors determines whether there is an up-to-date firmware file according to the first data and the at least one second data to transmit the up-to-date firmware file to corresponding at least one other projector among the projectors. Each of the at least one other projector receives the up-to-date firmware file to perform a firmware update.

### CROSS-REFERENCE TO RELATED APPLICATION

This application claims the priority benefit of China application serial no. 202311464381.4, filed on Nov. 6, 2023. The entirety of the above-mentioned patent application is hereby incorporated by reference herein and made a part of this specification.

### BACKGROUND

### Technical Field

The disclosure relates to a projector system, and in particular to a projector system, a firmware update method, and a projector.

### Description of Related Art

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

Generally speaking, there is more than one projector inside a mechanism. Whenever the firmware of the projectors needs to be updated, each projector needs to be manually checked and a firmware update operation is performed on each projector, which consumes a lot of manpower and time. In addition, multiple projectors of some mechanisms cannot be connected to an external network (for example, the Internet) and can only be connected to an internal local area network, which makes it more difficult to remotely perform the firmware update.

### SUMMARY

Other objectives, features, and advantages of the disclosure will be further understood from the further technological features disclosed by the embodiments of the disclosure, wherein there are shown and described preferred embodiments of this invention, simply by way of illustration of modes best suited to carry out the invention.

In order to achieve one, a part, or all of the above objectives or other objectives, an embodiment of the disclosure provides a projector system, including multiple projectors connected to each other via a network. Each of the projectors includes a processor, a communication circuit unit, an input/output unit, a storage circuit unit, and a memory. The processor is coupled to the communication circuit unit, the input/output unit, the storage circuit unit, and the memory. The communication circuit unit is configured to connect to the network. The projectors include a first projector and at least one second projector. A first processor of the first projector performs a first communication procedure in response to a first input operation applied to a first input/output unit. The first communication procedure includes a first communication circuit unit of the first projector broadcasting first data to each of the at least one second projector. A second processor of each of the at least one second projector performs a second communication procedure in response to receiving the first data. The second communication procedure includes a second communication circuit unit of each of the at least one second projector broadcasting corresponding second data to other projectors among the projectors. When the processor of each of the projectors determines that the first communication procedure and the second communication procedure are completed, the processor of each of the projectors determines whether there is an up-to-date firmware file in the storage circuit unit according to the first data and the at least one second data. When each of at least one of the projectors has the up-to-date firmware file in the storage circuit unit, each of at least one of the projectors transmits the up-to-date firmware file to corresponding at least one other projector among the projectors via the communication circuit unit. Each of the corresponding at least one other projector does not have the up-to-date firmware file. After each of at least one other projector among the projectors receives the up-to-date firmware file, the processor of each of the at least one other projector among the projectors performs a firmware update based on the up-to-date firmware file.

In an embodiment of the disclosure, the first communication circuit unit of the first projector broadcasts the first data via a first communication protocol, and the second communication circuit unit of each of the at least one second projector broadcasts the second data via the first communication protocol.

In an embodiment of the disclosure, the first data includes an IP identification code of the first projector, a model identification code of the first projector, a firmware version identification code of the first projector, and an initiation mark. The initiation mark of the first data is a first value. The second data includes an IP identification code of the second projector broadcasting the second data, a model identification code of the second projector, a firmware version identification code of the second projector, and the initiation mark. The initiation mark of the second data is a second value.

In an embodiment of the disclosure, after receiving the first data, in response to determining that the model identification code of the first projector is the same as the model identification code of the at least one second projector, the second processor of each of the at least one second projector stores the first data in its own second memory. In response to determining that the initiation mark in the first data is the first value, the second processor of each of the at least one second projector performs the second communication procedure to broadcast the second data via the second communication circuit unit.

In an embodiment of the disclosure, in the first communication procedure, the first processor of the first projector generates the first data according to its own information, and sets the initiation mark in the first data to the first value. The first processor of the first projector performs a first idle time counting procedure to count a first continuous idle time of not receiving any of the broadcasted second data. When the first continuous idle time is greater than a first idle time threshold, the first processor of the first projector determines that the first communication procedure has been completed. In addition, in the second communication procedure, the second processor of each of the at least one second projector generates the second data according to its own information, and sets the initiation mark in the second data to the second value. The second processor of each of the at least one second projector performs a second idle time counting procedure to count a second continuous idle time of not receiving any of the broadcasted second data. When the second continuous idle time is greater than a second idle time threshold, the second processor of each of the at least one second projector determines that the second communication procedure has been completed.

In an embodiment of the disclosure, in response to determining that the first communication procedure and the second communication procedure are completed, the first processor of the first projector uses at least one projector having the up-to-date firmware file among the projectors as at least one master projector and uses at least one projector not having the up-to-date firmware file among the projectors as at least one slave projector according to the first data and the second data of each of the at least one second projector. In addition, in response to determining that the first communication procedure and the second communication procedure are completed, the second processor of each of the at least one second projector uses the at least one projector having the up-to-date firmware file among the projectors as the at least one master projector and uses the at least one projector not having the up-to-date firmware file among the projectors as the at least one slave projector according to the first data and the second data of each of the at least one second projector. The model identification code of the at least one master projector is the same as the model identification code of the at least one slave projector, and the at least one master projector is configured to transmit the up-to-date firmware file to the at least one slave projector.

In an embodiment of the disclosure, after identifying the at least one master projector and the at least one slave projector, in response to determining that a local machine belongs to the at least one master projector, the processor of each of the at least one master projector performs a first mode firmware transmission procedure, including: selecting at least one from the at least one slave projector as a target slave projector according to a number of the at least one master projector, the IP identification code of each of the at least one master projector, a number of the at least one slave projector, and the IP identification code of each of the at least one slave projector; establishing a data connection conforming to a second communication protocol to the target slave projector; sending a firmware update request to the target slave projector; and transmitting the up-to-date firmware file to the target slave projector via the data connection conforming to the second communication protocol according to a firmware update response received from the target slave projector.

In an embodiment of the disclosure, after identifying the at least one master projector and the at least one slave projector, in response to determining that the local machine belongs to the at least one slave projector, the processor of each of the at least one slave projector performs a second mode firmware transmission procedure, including: establishing the data connection with the corresponding at least one master projector to become the target slave projector of the at least one master projector; in response to receiving the firmware update request from the corresponding at least one master projector, generating and transmitting the firmware update response to the corresponding at least one master projector according to a firmware update configuration of the local machine, and transmitting the up-to-date firmware file to the target slave projector according to the firmware update response by the corresponding at least one master projector; and in response to receiving the up-to-date firmware file, updating a firmware based on the up-to-date firmware file by the target slave projector.

In an embodiment of the disclosure, the target slave projector generates light by a lighting device, and the target slave projector generates corresponding light according to a firmware update progress.

In an embodiment of the disclosure, after each of the at least one second projector receives the first data, in response to determining that the initiation mark in the first data is the first value, the second processor of each of the at least one second projector calculates a delay time according to its own characteristic value, and starts performing the second communication procedure after the delay time to broadcast the second data via the second communication circuit unit. The characteristic values of the at least one second projector are different from each other.

Another embodiment of the disclosure provides a firmware update method, adapted to a projector system. The projector system includes multiple projectors. The projectors are connected to each other via a network. Each of the projectors includes a processor, a communication circuit unit, an input/output unit, a storage circuit unit, and a memory. The processor is coupled to the communication circuit unit, the input/output unit, the storage circuit unit, and the memory. The communication circuit unit is configured to connect to the network. The projectors include a first projector and at least one second projector. The firmware update method includes: in response to a first input operation applied to a first input/output unit of the first projector, performing a first communication procedure by a first processor of the first projector, wherein the first communication procedure includes a first communication circuit unit of the first projector broadcasting first data to each of the at least one second projector; in response to receiving the first data, performing a second communication procedure via a second processor of each of the at least one second projector, wherein the second communication procedure includes a second communication circuit unit of each of the at least one second projector broadcasting second data to other projectors among the projectors; when the processor of each of the projectors determines that the first communication procedure and the second communication procedure are completed, determining whether there is an up-to-date firmware file in the storage circuit unit according to the first data and the second data via the processor of each of the projectors; when each of at least one of the projectors has the up-to-date firmware file in the storage circuit unit, transmitting the up-to-date firmware file to corresponding at least one other projector among the projectors via the communication circuit unit of each of at least one of the projectors, wherein each of the corresponding at least one other projector does not have the up-to-date firmware file; and after each of the corresponding at least one other projector receives the up-to-date firmware file, performing a firmware update based on the up-to-date firmware file by the processor of each of the corresponding at least one other projector.

Yet another embodiment of the disclosure provides a projector, including a processor, a communication circuit unit, an input/output unit, and a memory. The processor is coupled to the communication circuit unit, the input/output unit, and the memory. The communication circuit unit is configured to connect to a network. In response to a first input operation applied to the input/output unit, the processor performs a first communication procedure. The first communication procedure includes: generating first data according to information of the projector, and setting an initiation mark in the first data to a first value by the processor; broadcasting the first data using a first communication protocol through the communication circuit unit; receiving at least one second data broadcasted by at least one other projector via the network using the first communication protocol through the communication circuit unit, and storing the at least one second data in the memory; and performing an idle time counting procedure by the processor to count a continuous idle time of not receiving any broadcasted second data. When the continuous idle time is greater than an idle time threshold, the processor determines that the first communication procedure has been completed. In addition, the processor determines whether the projector and the at least one other projector have an up-to-date firmware file according to the first data and the at least one second data.

Still yet another embodiment of the disclosure provides a projector, including a processor, a communication circuit unit, and a memory. The processor is coupled to the communication circuit unit and the memory. The communication circuit unit is configured to connect to a network. The processor identifies at least one master projector having an up-to-date firmware file and at least one of slave projector not having the up-to-date firmware file among multiple projectors connected to the network according to first data and at least one second data stored in the memory. In response to determining that the projector is one of the at least one master projector, the processor is configured to perform a firmware transmission procedure, including: in response to determining that a number of the at least one master projector is not greater than one, establishing a data connection to a target slave projector among the at least one slave projector using a default communication protocol through the communication circuit unit; in response to determining that the number of the at least one master projector is greater than one, grouping the at least one master projector and the at least one slave projector into multiple firmware transmission groups according to the number of the at least one master projector, an IP identification code of each of the at least one master projector, a number of the at least one slave projector, and an IP identification code of each of the at least one slave projector, and establishing a data connection to a target slave projector in a same firmware transmission group as the projector using the default communication protocol through the communication circuit unit, wherein the target slave projector is one of at least one slave projector in the same firmware transmission group as the projector; after establishing the data connection to the target slave projector, sending a firmware update request to the target slave projector through the data connection; transmitting the up-to-date firmware file to the target slave projector via the data connection according to a firmware update response received from the target slave projector; and in response to receiving a firmware reception completion notification from the target slave projector, selecting a slave projector from the at least one slave projector in the same firmware transmission group as the projector as another target slave projector to establish another data connection using the default communication protocol, and sending another firmware update request via the another data connection to transmit the up-to-date firmware file to the another target slave projector via the another data connection according to another firmware update response received from the another target slave projector.

Based on the above, the projector system, the firmware update method, and the projector provided by the embodiments of the disclosure have at least one of the following advantages: (1) all the projectors in the local network may be updated to the up-to-date firmware version in the local network; (2) only the first projector is required to trigger the local firmware update of the entire projector system, which saves a lot of manual operations in firmware file transmission, firmware version checking, and firmware update operations; and (3) there is no need to install an additional electronic apparatus such as a server in order to perform a firmware update of a mechanism.

### BRIEF DESCRIPTION OF THE DRAWINGS

FIG. 1A is a block schematic diagram of a projector system according to an embodiment of the disclosure.

FIG. 1B is a block schematic diagram of a projector of a projector system according to an embodiment of the disclosure.

FIG. 1C is a schematic diagram of a firmware update setting interface of a projector according to an embodiment of the disclosure.

FIG. 2 is a flowchart of a firmware update method according to an embodiment of the disclosure.

FIG. 3A is an operation flowchart of a first projector (UDP master) according to an embodiment of the disclosure.

FIG. 3B is an operation schematic diagram of a first communication procedure and a second communication procedure according to an embodiment of the disclosure.

FIG. 4A is an operation flowchart of a master projector (a TCP master) according to an embodiment of the disclosure.

FIG. 4B is an operation schematic diagram of a first mode firmware update procedure of a master projector (a TCP master) according to an embodiment of the disclosure.

FIG. 4C is an operation schematic diagram of a second mode firmware update procedure of a slave projector (a TCP slave) according to an embodiment of the disclosure.

FIG. 5 is an operation schematic diagram of a firmware update method according to an embodiment of the disclosure.

FIG. 6A is a block schematic diagram of a projector system performing a first communication procedure according to an embodiment of the disclosure.

FIG. 6B is a block schematic diagram of a projector system performing a second communication procedure according to an embodiment of the disclosure.

FIG. 7 is a block schematic diagram of a projector system performing a firmware transmission procedure according to an embodiment of the disclosure.

FIG. 8A is a block schematic diagram of a projector system having multiple master projectors according to an embodiment of the disclosure.

FIG. 8B is a block schematic diagram of a projector system performing a firmware transmission procedure via multiple firmware transmission groups according to an embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top”, “bottom”, “front”, “back”, etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

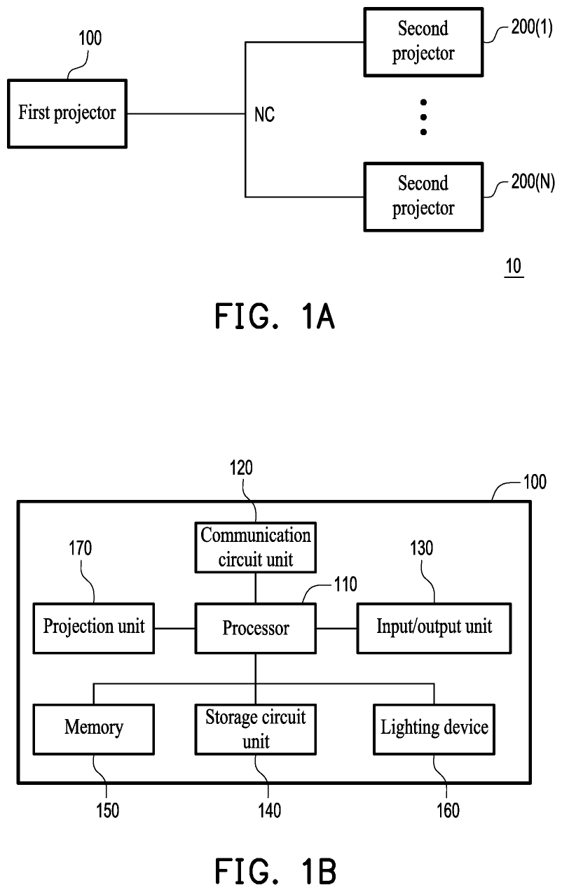

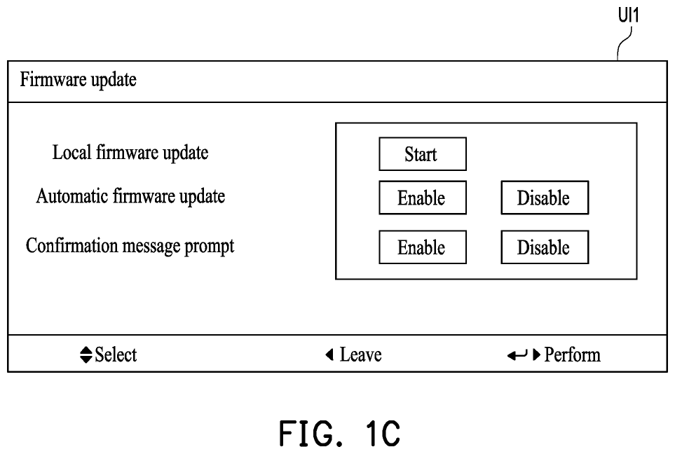

Please refer to FIG. 1A. In the embodiment, a projector system 10 includes multiple projectors. The projectors include a first projector 100 and second projectors 200(1) to 200(N). The first projector 100 is connected to the second projectors 200(1) to 200(N) via a network connection NC. The network connection NC is, for example, a local area network. Here, the first projector 100 refers to a projector that initiates a local network firmware update (also known as a local firmware update). The local firmware update generally refers to a firmware update method provided by the disclosure and is used by the projector system 10 to transmit an up-to-date firmware file of the projector system 10 from a master projector to one or more slave projectors not having the up-to-date firmware file, so that the slave projector may perform a firmware update according to the received up-to-date firmware file.

Please refer to FIG. 1B. Each projector (taking the projector 100 as an example) of the projector system 10 includes a processor 110, a communication circuit unit 120, an input/output unit 130, a storage circuit unit 140, a memory 150, a lighting device 160, and a projection unit 170. The processor 110 is electrically connected (coupled) to the communication circuit unit 120, the input/output unit 130, the storage circuit unit 140, the memory 150, the lighting device 160, and the projection unit 170 and is configured to control/manage the overall operation of the projector 100.

The processor 110 is, for example, a microprogrammed control unit, a central processing unit (CPU), a programmable microprocessor, an application specific integrated circuit (ASIC), a programmable logic device (PLD), or other similar devices.

The communication circuit unit 120 is configured to transmit or receive data through wired or wireless communication. In the embodiment, the communication circuit unit may have a wireless communication circuit module (not shown) and support one of a global system for mobile communication (GSM), a wireless fidelity (WiFi) system, and Bluetooth communication technology or a combination thereof, but not limited thereto.

The input/output unit 130 includes an input apparatus and an output apparatus. The input apparatus is, for example, an apparatus such as a microphone, a touch pad, a touch panel, a knob, and a button and is configured to allow a user to input data or control a function that the user intends to operate. The output apparatus is, for example, an apparatus such as a display (which is configured to receive data of a display screen to display an image) and a speaker (which is configured to receive audio data to produce a sound effect), but the disclosure is not limited thereto. In an embodiment, the input/output unit 130 may include a touch screen. The touch screen is configured to display various information and control interfaces of a projector, such as displaying an on-screen display (OSD) interface (such as an OSD interface UI1 shown in FIG. 1C) corresponding to a firmware update setting.

The storage circuit unit 140 may store data via an instruction of the processor 110. The storage circuit unit includes any type of hard disk drive (HDD) or non-volatile memory storage device (for example, an SSD or a flash memory).

The memory 150 is configured to temporarily store a command or data performed by the processor 110 and is, for example, a dynamic random access memory (DRAM), a static random access memory (SRAM), etc.

The lighting device 160 is configured to display different lights according to a command/control signal of the processor 110. The different lights may reflect the current operating status of the projector. The projection unit 170 is configured to perform a projection operation according to image data according to the instruction of the processor 110 to project an image. In an embodiment, the projector 100 further includes a data transmission interface (not shown) to connect to an external electronic device, thereby receiving the image data from the electronic device.

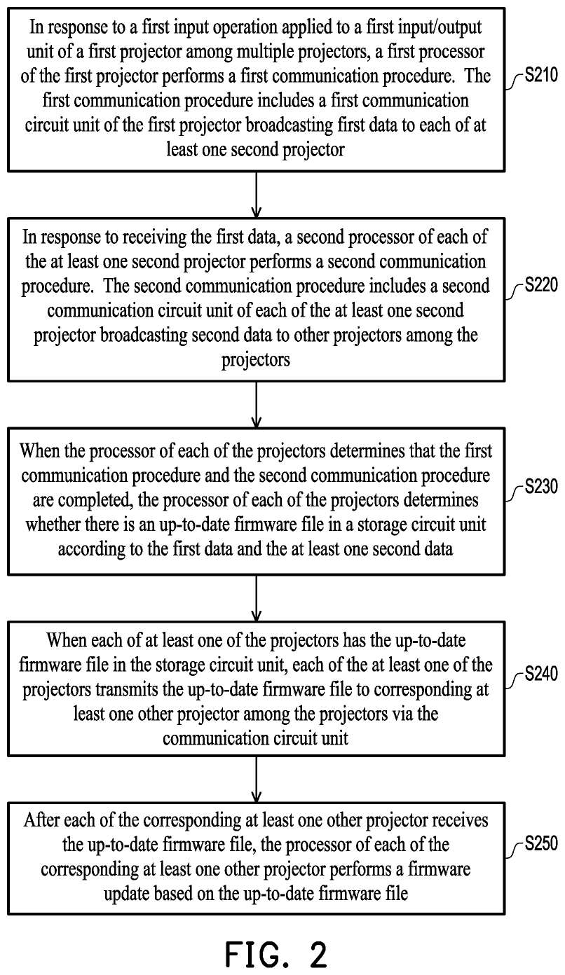

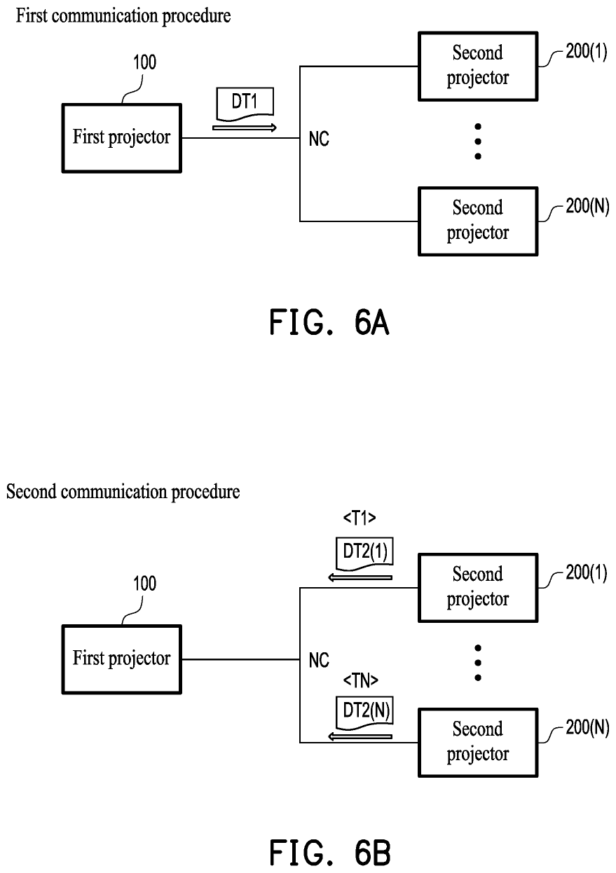

Please refer to FIG. 2 and FIG. 6A. In Step S210, in response to a first input operation applied to the first input/output unit 130 of the first projector 100 among the projectors, the first processor 110 of the first projector 100 performs a first communication procedure. The first communication procedure includes the first communication circuit unit 120 of the first projector 100 broadcasting first data DT1 to each of the at least one second projectors 200(1) to 200(N) (as shown in FIG. 6A). The first input operation is, for example, triggering a “local firmware update-start” button of the OSD interface UI1 as shown in FIG. 1C via a touch operation or a press operation. When the button is triggered, other projectors in the same local network receive the broadcasted first data.

Please refer to FIG. 2 and FIG. 6B. Next, in Step S220, in response to receiving the first data DT1, a second processor of each of the at least one second projectors 200(1) to 200(N) performs a second communication procedure. The second communication procedure includes a second communication circuit unit of each of the at least one second projectors 200(1) to 200(N) broadcasting second data DT2(1) to DT2(N) to other projectors among the projectors. For example, it is assumed that the projector broadcasting the second data is the second projector 200(1), and the other projectors are the projector 100 and the projectors 200(2) to 200(N).

Specifically, in response to determining that a model identification code of the first projector is the same as model identification codes of the at least one second projectors 200(1) to 200(N), the second processor of each of the at least one second projectors 200(1) to 200(N) stores the first data DT1 in its own second memory.

In response to determining that an initiation mark in the first data DT1 is a first value, the second processor of each of the at least one second projectors 200(1) to 200(N) performs the second communication procedure to broadcast the second data DT2(1) to DT2(N) via the second communication circuit unit.

It should be noted that time points T1 to TN of broadcasting the second data DT2(1) to DT2(N) are different from each other. In the embodiment, after each of the at least one second projectors 200(1) to 200(N) receives the first data DT1, in response to determining that the initiation mark in the first data DT1 is the first value, the second processor of each of the at least one second projectors 200(1) to 200(N) calculates a delay time according to its own characteristic value (for example, an IP identification code, a UID of the projector), and starts to perform the second communication procedure after the delay time has passed to broadcast the second data DT2(1) to DT2(N) via the second communication circuit unit, wherein the characteristic values of the at least one second projectors 200(1) to 200(N) are different from each other. Since the characteristic values of the at least one second projectors 200(1) to 200(N) are different from each other, the respective delay times of the at least one second projectors 200(1) to 200(N) are also different, thereby causing the time points T1 to TN of broadcasting the second data DT2(1) to DT2(N) to also be different.

In the embodiment, the first communication circuit unit 120 of the first projector 100 broadcasts the first data using a first communication protocol. The first communication protocol is, for example, a user datagram protocol (UDP), also known as a UDP communication protocol. The second communication circuit unit of each of the at least one second projector also broadcasts the second data via the first communication protocol.

In addition, the first data includes the IP identification code of the first projector, the model identification code of the first projector, the firmware version identification code of the first projector, and the initiation mark, wherein the initiation mark of the first data is the first value. In the embodiment, the first processor 110 of the first projector 100 that initiates the local firmware update generates the first data according to the information (for example, the IP identification code, the model identification code, and the firmware version identification code) of the first projector 100, and sets the initiation mark in the first data to the first value (for example, “1”) in the first communication procedure.

The second data includes the IP identification code of the second projector broadcasting the second data, the model identification code of the second projector, the firmware version identification code of the second projector, and the initiation mark, wherein the initiation mark of the second data is the second value. In other words, the second projector broadcasting the second data generates the second data according to the information (for example, the IP identification code, the model identification code, and the firmware version identification code) of the second projector itself, and sets the initiation mark in the first data to the second value (for example, “0”) in the second communication procedure.

Next, in Step S230, when the processor of each of the projectors determines that the first communication procedure and the second communication procedure are completed, the processor of each of the projectors determines whether there is the up-to-date firmware file in the storage circuit unit according to the first data and the at least one second data.

More specifically, in response to determining that the first communication procedure and the second communication procedure are completed, the first processor of the first projector 100 uses at least one projector having the up-to-date firmware file among the projectors as at least one master projector and uses at least one projector not having the up-to-date firmware file among the projectors as at least one slave projector according to the first data and the second data of each of the at least one second projectors 200(1) to 200(N). In response to determining that the first communication procedure and the second communication procedure are completed, the second processor of each of the at least one second projectors 200(1) to 200(N) uses the at least one projector having the up-to-date firmware file among the projectors as the at least one master projector and uses the at least one projector not having the up-to-date firmware file among the projectors as the at least one slave projector according to the first data and the second data of each of the at least one second projectors 200(1) to 200(N), wherein the model identification code of the at least one master projector is the same as the model identification code of the at least one slave projector, and the at least one master projector is configured to transmit the up-to-date firmware file to the at least one slave projector.

Simply put, when the first projector 100 has not received the second data from other projectors after a period of idle time, the first projector 100 determines that the first communication procedure is completed; and when each second projector has not received the second data from any other projector after a period of idle time, each second projector determines that the second communication procedure is completed. In this case, each projector starts to identify/compare the models, the firmware versions, and the IP addresses of all the projectors according to the received first data and second data. The projector having the up-to-date firmware file (also known as the master projector) and the projector not having the up-to-date firmware file (also known as the slave projector) may be determined according to the firmware versions.

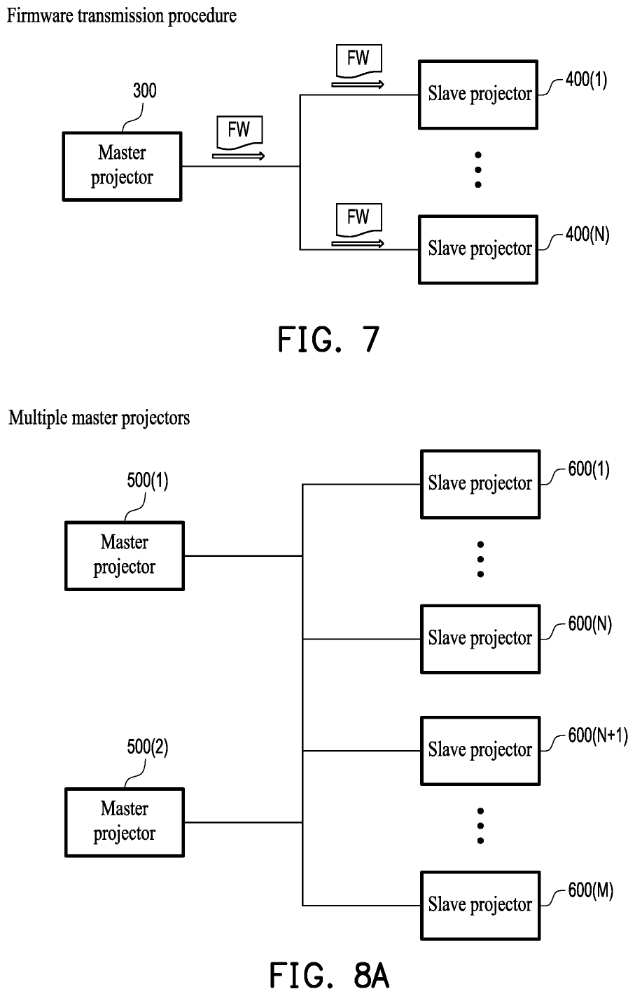

Please refer to FIG. 2 and FIG. 7. In Step S240, when each of at least one (for example, a master projector 300) of the projectors has the up-to-date firmware file in the storage circuit unit, each of the at least one of the projectors transmits the up-to-date firmware file (for example, FW) to corresponding at least one other projector (for example, slave projectors 400(1) to 400(N)) among the projectors via the communication circuit unit.

Next, in Step S250, after each of the corresponding at least one other projector receives the up-to-date firmware file, the processor of each of the corresponding at least one other projector performs the firmware update based on the up-to-date firmware file.

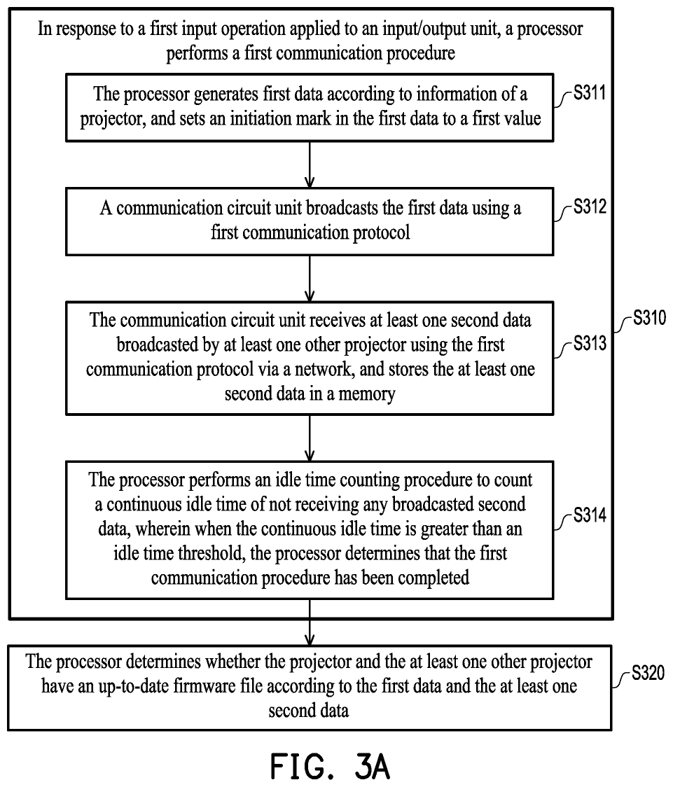

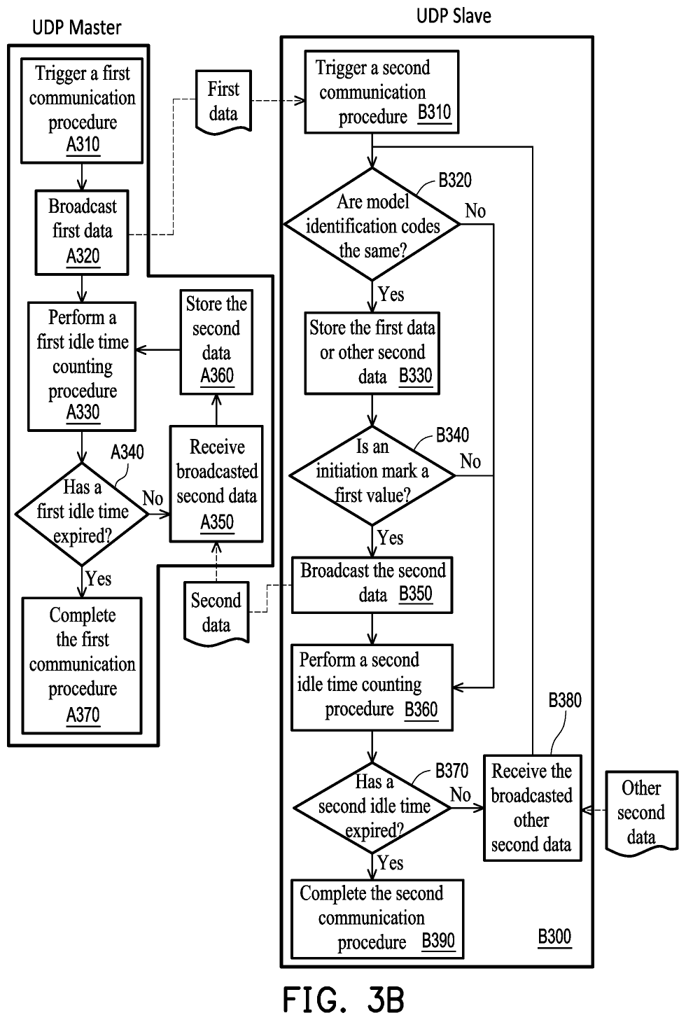

The following describes the operation details of the first projector 100 with FIG. 3A, FIG. 6A, and FIG. 6B. Please refer to FIG. 3A. In Step S310, in response to the first input operation applied to the input/output unit, the processor 110 of the first projector 100 performs the first communication procedure. The first communication procedure includes Steps S311 to S314. In Step S311, the processor generates the first data DT1 according to the information of the projector, and sets the initiation mark in the first data DT1 to the first value. In Step S312, the communication circuit unit 120 broadcasts the first data DT1 using the first communication protocol. In Step S313, the communication circuit unit 120 receives the at least one second data DT2(1) to DT(N) broadcasted by at least one other projector 200(1) to 200(N) using the first communication protocol via the network NC, and stores the at least one second data DT2(1) to DT(N) in the memory 150. Next, in Step S314, the processor 110 performs an idle time counting procedure (also known as a first idle time counting procedure) to count a continuous idle time (also known as a first continuous idle time) of not receiving any broadcasted second data, wherein when the continuous idle time is greater than an idle time threshold (also known as a first idle time threshold), the processor determines that the first communication procedure has been completed. It should be noted that the first idle time counting procedure is reset whenever any second data is received.

Next, in Step S320, the processor 110 determines whether the projector 100 and the at least one other projector 200(1) to 200(N) have the up-to-date firmware file according to the first data DT and the at least one second data DT2(1) to DT(N).

The following describes the operation details of the first communication procedure and the second communication procedure with FIG. 3B. Please refer to FIG. 3B. In the embodiment, the first projector performing the first communication procedure may be known as a UDP master and the second projector performing the second communication procedure may be known as a UDP slave.

First, the first communication procedure of the first projector is triggered (A310) to broadcast the first data (A320), and perform the first idle time counting procedure (A330). The first data is broadcasted to the second projector to trigger the second communication procedure of the second projector (B310). After the second projector receives the first data, in response to determining that the model identification code of the first data is the same as the model identification code of the second projector (B320→Yes), the second projector stores the first data (B330). In response to determining that the initiation mark of the first data is the first value (B340→Yes), the second projector broadcasts its own second data (B350), and performs the second idle time counting procedure (B360). At this time, the second projector performs the second idle time counting procedure to count a second continuous idle time of not receiving any of the broadcasted second data. When the second continuous idle time is greater than a second idle time threshold (B370→Yes), the second projector determines that the second communication procedure has been completed (B390).

On the other hand, in response to determining that the model identification codes are not the same (B320→No), the second projector ignores the first data and continues to count the second idle time. It should be noted that whenever the second projector receives the second data from other projectors (B380), the second projector performs Step B320 and subsequent operations on the received other second data, and the second idle time counting procedure is reset.

As shown in FIG. 3B, the second data broadcasted by the second projector is received by the first projector (A350), and the second data is stored in the memory 150 (A360). At this time, the first idle time counting procedure is reset (A330). In response to the first continuous idle time of no longer receiving the second data exceeding the first idle time threshold (A340→Yes), the first projector determines that the first communication procedure is completed (A370).

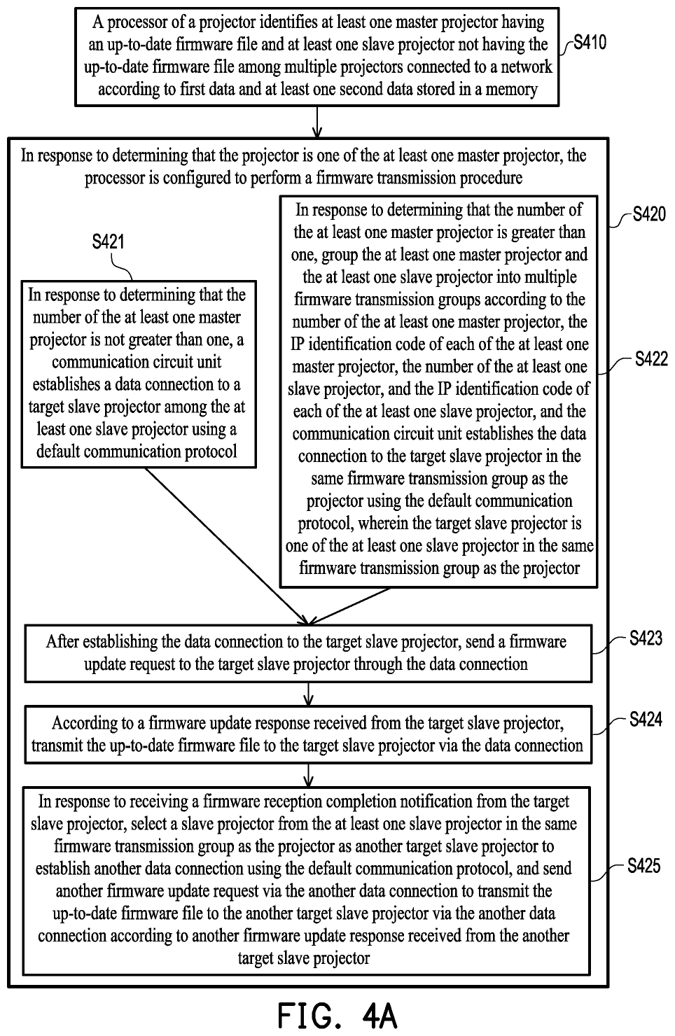

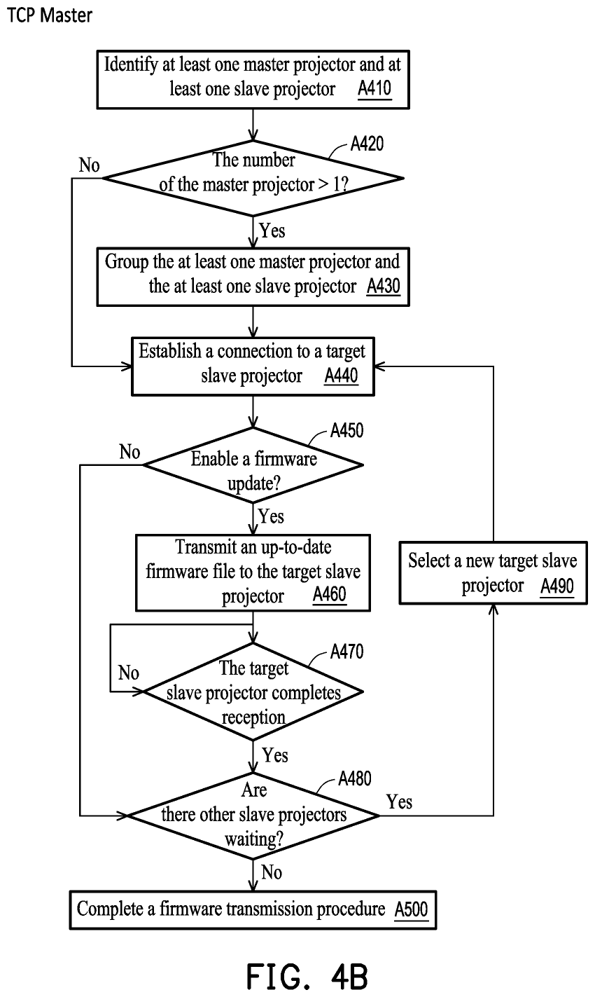

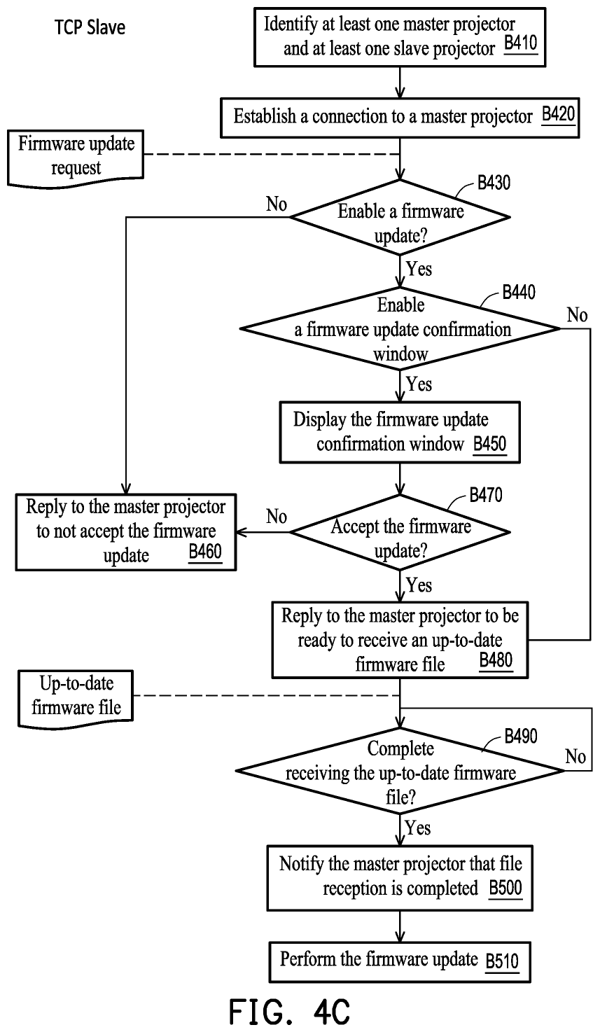

The following describes the operation details of the master projector 300 with FIG. 4A and FIG. 7. Please refer to FIG. 4A. In Step S410, the processor of the projector identifies at least one master projector having the up-to-date firmware file and at least one slave projector not having the up-to-date firmware file among the projectors connected to the network according to the first data and the at least one second data stored in the memory.

Next, in Step S420, in response to determining that the projector itself is one of the at least one master projector, the processor is configured to perform a firmware transmission procedure. The firmware transmission procedure includes Steps S421 to S425.

In Step S421, in response to determining that the number of the at least one master projector is not greater than one, the communication circuit unit establishes a data connection to a target slave projector among the at least one slave projector using a default communication protocol (also known as a second communication protocol). The default communication protocol is, for example, a transmission control protocol (TCP), also known as a TCP communication protocol. In addition, the master projector may also be known as a TCP master, and the slave projector may be known as a TCP slave.

In Step S422, in response to determining that the number of the at least one master projector is greater than one, the master projector groups the at least one master projector and the at least one slave projector into multiple firmware transmission groups according to the number of the at least one master projector, the IP identification code of each of the at least one master projector, the number of the at least one slave projector, and the IP identification code of each of the at least one slave projector, and the communication circuit unit establishes the data connection to the target slave projector in the same firmware transmission group as the projector using the default communication protocol, wherein the target slave projector is one of the at least one slave projector in the same firmware transmission group as the projector.

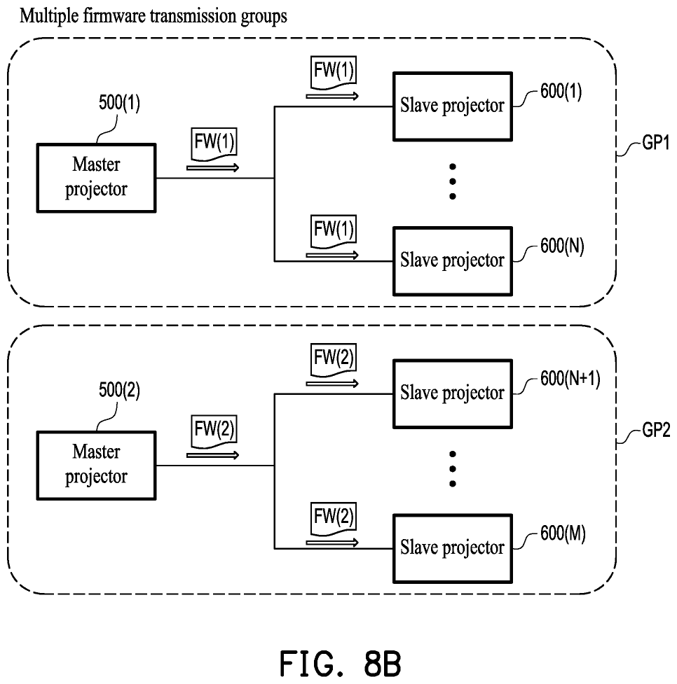

Please refer to FIG. 8A and FIG. 8B. It is assumed that the projector system has two master projectors 500(1) and 500(2) and multiple slave projectors 600(1) to 600(M). Each projector may be grouped according to the number and the IP identification codes of all the master projectors and the number and the IP identification codes of all the slave projectors. For example, corresponding to two master projectors, the number of the firmware transmission groups is also set to two (for example, firmware transmission groups GP1 and GP2), so that each firmware transmission group has one master projector. Additionally, the number of the slave projectors of each firmware transmission group may be allocated according to the number of the firmware transmission groups. For example, the slave projectors whose IP identification codes have odd-numbered endings are grouped into the firmware transmission group GP1, and the slave projectors whose IP identification codes have even-numbered endings are grouped into the firmware transmission group GP2. For another example, all the slave projectors may be sorted according to the IP identification codes, and the slave projectors whose orders are odd numbers are allocated to the firmware transmission group GP1, and the slave projectors whose orders are even numbers are allocated to the firmware transmission group GP2.

The master projector of each firmware transmission group is configured to transmit its own up-to-date firmware file to the slave projector in the same group (for example, the master projector 500(1) transmits an up-to-date firmware file FW(1) and the master projector 500(2) transmits an up-to-date firmware file FW(2). The master projectors 500(1) and 500(2) may select at least one from the slave projectors as the target slave projector according to the order of the IP identification codes of the slave projectors in the same group to establish the data connection conforming to the second communication protocol to the target slave projector.

Next, in Step S423, after establishing the data connection to the target slave projector, a firmware update request is sent to the target slave projector through the data connection.

Next, in Step S424, according to a firmware update response received from the target slave projector, the up-to-date firmware file is transmitted to the target slave projector via the data connection. For example, assuming that the firmware update response instructs the target slave projector to accept the firmware update, the master projector transmits the up-to-date firmware file to the target slave projector via the data connection. For another example, assuming that the firmware update response instructs the target slave projector to not accept the firmware update, the master projector cuts off the data connection, and selects the next other slave projector that has not been queried by the firmware update request as a new target slave projector.

Next, in Step S425, in response to receiving a firmware reception completion notification from the target slave projector, a slave projector is selected from the at least one slave projector in the same firmware transmission group as the projector as another target slave projector to establish another data connection using the default communication protocol, and another firmware update request is sent via the another data connection to transmit the up-to-date firmware file to the another target slave projector via the another data connection according to another firmware update response received from the another target slave projector.

Simply put, in response to receiving the firmware reception completion notification from the target slave projector, the master projector may know that the up-to-date firmware file has been completely received by the target slave projector, and the master projector may cut off the data connection, and select another slave projector that has not received the firmware update request to perform another data connection to try to transmit the up-to-date firmware file to the another slave projector.

FIG. 4B is an operation schematic diagram of a first mode firmware update procedure of a master projector (a TCP master) according to an embodiment of the disclosure. Please refer to FIG. 4B. After identifying the at least one master projector and the at least one slave projector (A410), the master projector determines whether to perform grouping according to the number of the master projectors (A420). If the number of the master projectors is greater than 1 (A420→Yes), all the master projectors and the slave projectors are grouped (A430) and a connection to the selected target slave projector is established (A440). If the number of the master projector is not greater than 1 (A420→No), no grouping is performed and a connection to the selected target slave projector is established (A440). In response to the target slave projector accepting the firmware update (A450→Yes), the master projector transmits the up-to-date firmware file to the target slave projector (A460). In response to the target slave projector receiving the up-to-date firmware file (A470→Yes), the master projector determines whether there are other slave projectors waiting for the up-to-date firmware file to be transmitted (A480). In response to there being other slave projectors waiting for the up-to-date firmware file to be transmitted (A480→Yes), the master slave projector selects the new target slave projector (A490), and the process returns to Step A440. In addition, in response to there being no other slave projector waiting for the up-to-date firmware file to be transmitted (A480→No), the master and slave projectors complete the firmware transmission procedure (A500).

On the other hand, if the target slave projector does not accept the firmware update (A450→No), the master projector determines whether there are other slave projectors waiting for the up-to-date firmware file to be transmitted (A480).

Simply put, after identifying the at least one master projector and the at least one slave projector, in response to determining that a local machine belongs to the at least one master projector, the processor of each of the at least one master projector performs a first mode firmware transmission procedure. The first mode firmware transmission procedure includes selecting at least one from the at least one projector as the target slave projector according to the number of the at least one master projector, the IP identification code of each of the at least one master projector, the number of the at least one slave projector, and the IP identification code of each of the at least one slave projector; establishing the data connection conforming to the second communication protocol to the target slave projector; sending the firmware update request to the target slave projector; and transmitting the up-to-date firmware file to the target slave projector via the data connection conforming to the second communication protocol according to the firmware update response received from the target slave projector.

FIG. 4C is an operation schematic diagram of a second mode firmware update procedure slave projector (a TCP slave) according to an embodiment of the disclosure. Please refer to FIG. 4C. After identifying the at least one master projector and the at least one slave projector (B410), the projector knows that the projector itself is a slave projector and waits for a request to establish a data connection by the master projector. Next, the slave projector and the master projector establish the data connection (B420). After receiving the firmware update request from the master projector, the projector may determine whether to enable the firmware update by a firmware update configuration, and determine whether to enable a firmware update confirmation window, thereby determining how to reply to the firmware update request.

In the embodiment, the firmware update configuration may be set via a firmware update interface. For example, please refer to FIG. 1C. A firmware update interface UI1 has three main options: (1) a local firmware update option, configured to decide whether to initiate the local firmware update; (2) an automatic firmware update option, configured to set whether to accept the local firmware update; and (3) a confirmation message prompt option, configured to set whether to enable the firmware update confirmation window to query the user whether to accept an update firmware file to update a firmware. In order to prevent the user from being disturbed by a suddenly performed firmware update, the automatic firmware update option is disabled by default.

In response to determining not to enable the firmware update (B430→No) (for example, the automatic firmware update option is set to disabled), the slave projector replies to the master projector not to accept the firmware update (for example, the firmware update response transmitted to the master projector includes the second value “0”) (B460). In response to determining to enable the firmware update (B4300→Yes) (for example, the automatic firmware update option is set to enabled), the slave projector then determines whether to enable the firmware update confirmation window (B440).

In response to determining to enable the firmware update confirmation window (B440→Yes) (for example, the confirmation message prompt option is set to enabled), the slave projector displays the firmware update confirmation window (B450), and determines whether to accept the firmware update according to a response to a received input operation (B470). For example, when the user triggers an option/button configured to instruct to accept the firmware update in the firmware update confirmation window, the slave projector determines that the response to the input operation instructs a reply to the master projector to accept the firmware update (for example, the firmware update response transmitted to the master projector includes the first value “1”) and is ready to receive the up-to-date firmware file (B480). For another example, when the user triggers an option/button configured to instruct to not accept the firmware update in the firmware update confirmation window, the slave projector determines that the response to the input operation instructs a reply to the master projector to not accept the firmware update (for example, the firmware update response transmitted to the master projector includes the second value “0”) (B460).

In response to determining not to enable the firmware update confirmation window (B440→No), the slave projector directly replies to the master projector to be ready to receive the up-to-date firmware file (B480). The up-to-date firmware file is transmitted to the slave projector via the data connection.

Then, in response to receiving all the firmware update files (B490→Yes), the projector notifies the master projector that file reception is completed (B500), and the slave projector may use the up-to-date firmware file to perform the firmware update (B510).

Simply put, after identifying the at least one master projector and the at least one slave projector, in response to determining that the local machine belongs to the at least one slave projector, the processor of each of the at least one slave projector performs a second mode firmware transmission procedure. The second mode firmware transmission procedure includes establishing the data connection with the corresponding at least one master projector to become the target slave projector of the at least one master projector; in response to receiving the firmware update request from the corresponding at least one master projector, generating and transmitting the firmware update response to the corresponding at least one master projector according to the firmware update configuration of the local machine, and transmitting the up-to-date firmware file to the target slave projector according to the firmware update response by the corresponding at least one master projector; and in response to receiving the up-to-date firmware file, updating the firmware based on the up-to-date firmware file by the target slave projector.

In an embodiment, the target slave projector generates light by a lighting device, and the target slave projector generates corresponding light according to a firmware update progress. The lighting device may be an LED. In addition to showing the update progress, different light signals include a first light signal, configured to indicate receiving the up-to-date firmware file; a second light signal, configured to indicate sending the up-to-date firmware file; a third light signal, configured to indicate completing the firmware update; a fourth light signal, configured to indicate update failure; and a fifth light signal, configured to indicate that the firmware update is being performed.

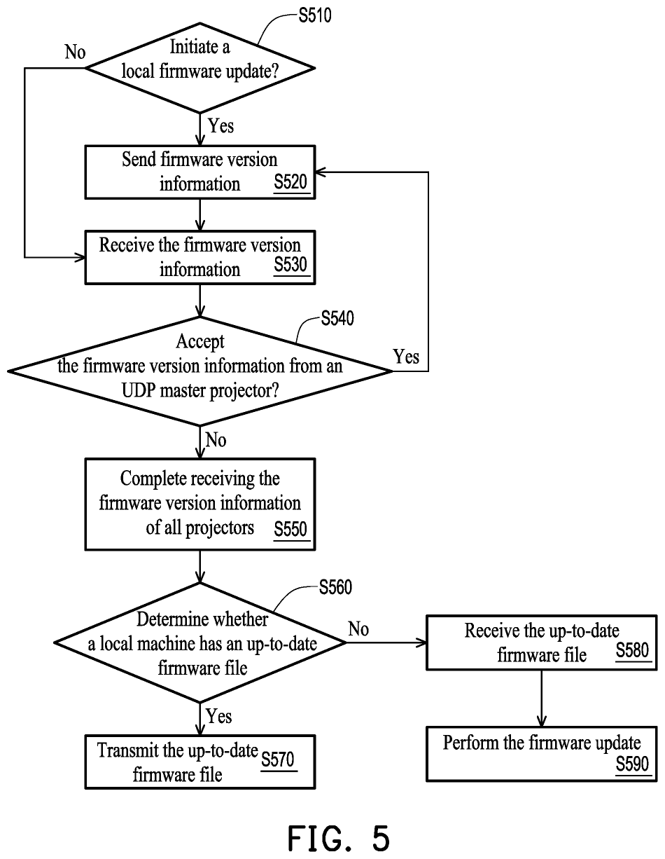

FIG. 5 is an operation schematic diagram of a firmware update method according to an embodiment of the disclosure. Please refer to FIG. 5. Initially, in response to the first projector initiating the local firmware update (S510→Yes), each projector broadcasts its own information (for example, firmware version information, etc.) (S520), and receives information broadcasted from other projectors (S530).

If a projector receives information (for example, the first data with the initiation mark being the first value) from the first projector (S540→Yes), the projector broadcasts its own information (S520).

After completing receiving the broadcast information of all other projectors (S550), each projector identifies all master projectors and slave projectors, and determine whether the projector itself is one of the master projectors having the up-to-date firmware file (S560). If yes, the up-to-date firmware file is transmitted to the target slave projector (S570); and if no, the up-to-date firmware file from the master projector is received (S580), and the firmware update is performed accordingly (S590).

It is worth mentioning that in the above embodiment, as shown in FIG. 7, the up-to-date firmware files FW are transmitted one by one from the master projector 300 to the slave projectors 400(1) to 400(N), but the disclosure is not limited thereto. For example, in another embodiment, in the example of FIG. 7, each projector may determine the order of serving as the master projector and the corresponding target slave projector according to the first data and the second data. For example, the set order of serving as the master projector is the master projector 300, the slave projector 400(1), the slave projector 400(2), . . . , the slave projector (N). Assuming that the first master projector 300 first transmits the up-to-date firmware file to the slave projector 400(1), after updating the firmware, the slave projector 400(1) serves as a second master projector and is responsible for transmitting the up-to-date firmware file to the next projector, that is, the slave projector 400(2), and so on. In other words, in the embodiment, whenever the master projector completes transmitting the up-to-date firmware file, the master projector does not need to continue transmitting the up-to-date firmware file. Instead, it is the turn of the target slave projector to replace the master projector to transmit the up-to-date firmware file to the next target slave projector. In this way, the master projector 300 will not be in a busy state due to being responsible for transmitting the up-to-date firmware file all the time.

In summary, the projector system, the firmware update method, and the projector provided by the embodiments of the disclosure have at least one of the following advantages: (1) all the projectors in the local network may be updated to the up-to-date firmware version in the local network; (2) only the first projector is required to trigger the local firmware update of the entire projector system, which saves a lot of manual operations in firmware file transmission, firmware version checking, and firmware update operations; and (3) there is no need to install an additional electronic apparatus such as a server in order to perform a firmware update of a mechanism.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the disclosure” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be configured to interpret or limit the scope or meaning of the claims. Any advantages and benefits described may not apply to all embodiments of the invention. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. A projector system, comprising:
a plurality of projectors, connected to each other via a network, wherein each of the projectors comprises a processor, a communication circuit unit, an input/output unit, a storage circuit unit, and a memory, wherein the processor is coupled to the communication circuit unit, the input/output unit, the storage circuit unit, and the memory, wherein the communication circuit unit is configured to connect to the network,
wherein the projectors comprise a first projector and at least one second projector, a first processor of the first projector performs a first communication procedure in response to a first input operation applied to a first input/output unit, and the first communication procedure comprises a first communication circuit unit of the first projector broadcasting first data to each of the at least one second projector,
wherein a second processor of each of the at least one second projector performs a second communication procedure in response to receiving the first data, and the second communication procedure comprises a second communication circuit unit of each of the at least one second projector broadcasting corresponding second data to other projectors among the projectors,
wherein when the processor of each of the projectors determines that the first communication procedure and the second communication procedure are completed, the processor of each of the projectors determines whether there is an up-to-date firmware file in the storage circuit unit according to the first data and the at least one second data,
wherein when each of at least one of the projectors has the up-to-date firmware file in the storage circuit unit, each of at least one of the projectors transmits the up-to-date firmware file to corresponding at least one other projector among the projectors via the communication circuit unit, wherein each of the corresponding at least one other projector does not have the up-to-date firmware file,
wherein after each of at least one other projector among the projectors receives the up-to-date firmware file, the processor of each of the at least one other projector among the projectors performs a firmware update based on the up-to-date firmware file.

2. The projector system according to claim 1, wherein:
the first communication circuit unit of the first projector broadcasts the first data via a first communication protocol, and the second communication circuit unit of each of the at least one second projector broadcasts the second data via the first communication protocol.

3. The projector system according to claim 1, wherein:
the first data comprises an IP identification code of the first projector, a model identification code of the first projector, a firmware version identification code of the first projector, and an initiation mark, wherein the initiation mark of the first data is a first value,
the second data comprises an IP identification code of the second projector broadcasting the second data, a model identification code of the second projector, a firmware version identification code of the second projector, and the initiation mark, wherein the initiation mark of the second data is a second value.

4. The projector system according to claim 3, wherein after receiving the first data,
in response to determining that the model identification code of the first projector is the same as the model identification code of the at least one second projector, the second processor of each of the at least one second projector stores the first data in its own second memory,
in response to determining that the initiation mark in the first data is the first value, the second processor of each of the at least one second projector performs the second communication procedure to broadcast the second data via the second communication circuit unit.

5. The projector system according to claim 4, wherein in the first communication procedure,
the first processor of the first projector generates the first data according to its own information, and sets the initiation mark in the first data to the first value,
the first processor of the first projector performs a first idle time counting procedure to count a first continuous idle time of not receiving any of the broadcasted second data,
when the first continuous idle time is greater than a first idle time threshold, the first processor of the first projector determines that the first communication procedure has been completed,
wherein in the second communication procedure,
the second processor of each of the at least one second projector generates the second data according to its own information, and sets the initiation mark in the second data to the second value,
the second processor of each of the at least one second projector performs a second idle time counting procedure to count a second continuous idle time of not receiving any of the broadcasted second data,
when the second continuous idle time is greater than a second idle time threshold, the second processor of each of the at least one second projector determines that the second communication procedure has been completed.

6. The projector system according to claim 5, wherein in response to determining that the first communication procedure and the second communication procedure are completed, the first processor of the first projector uses at least one projector having the up-to-date firmware file among the projectors as at least one master projector and uses at least one projector not having the up-to-date firmware file among the projectors as at least one slave projector according to the first data and the second data of each of the at least one second projector,
in response to determining that the first communication procedure and the second communication procedure are completed, the second processor of each of the at least one second projector uses the at least one projector having the up-to-date firmware file among the projectors as the at least one master projector and uses the at least one projector not having the up-to-date firmware file among the projectors as the at least one slave projector according to the first data and the second data of each of the at least one second projector, wherein the model identification code of the at least one master projector is the same as the model identification code of the at least one slave projector, and the at least one master projector is configured to transmit the up-to-date firmware file to the at least one slave projector.

7. The projector system according to claim 6, wherein after identifying the at least one master projector and the at least one slave projector,
in response to determining that a local machine belongs to the at least one master projector, the processor of each of the at least one master projector performs a first mode firmware transmission procedure, comprising:
selecting at least one from the at least one slave projector as a target slave projector according to a number of the at least one master projector, the IP identification code of each of the at least one master projector, a number of the at least one slave projector, and the IP identification code of each of the at least one slave projector;
establishing a data connection conforming to a second communication protocol to the target slave projector;
sending a firmware update request to the target slave projector; and
transmitting the up-to-date firmware file to the target slave projector via the data connection conforming to the second communication protocol according to a firmware update response received from the target slave projector.

8. The projector system according to claim 7, wherein after identifying the at least one master projector and the at least one slave projector,
in response to determining that the local machine belongs to the at least one slave projector, the processor of each of the at least one slave projector performs a second mode firmware transmission procedure, comprising:
establishing the data connection with the corresponding at least one master projector to become the target slave projector of the at least one master projector;
in response to receiving the firmware update request from the corresponding at least one master projector, generating and transmitting the firmware update response to the corresponding at least one master projector according to a firmware update configuration of the local machine, and transmitting the up-to-date firmware file to the target slave projector according to the firmware update response by the corresponding at least one master projector; and
in response to receiving the up-to-date firmware file, updating a firmware based on the up-to-date firmware file by the target slave projector.

9. The projector system according to claim 8, wherein the target slave projector generates light by a lighting device, and the target slave projector generates corresponding light according to a firmware update progress.

10. The projector system according to claim 4, wherein after each of the at least one second projector receives the first data, in response to determining that the initiation mark in the first data is the first value,
the second processor of each of the at least one second projector calculates a delay time according to its own characteristic value, and starts performing the second communication procedure after the delay time to broadcast the second data via the second communication circuit unit, wherein the characteristic values of the at least one second projector are different from each other.

11. A firmware update method, adapted to a projector system, wherein the projector system comprises a plurality of projectors, and the projectors are connected to each other via a network, wherein each of the projectors comprises a processor, a communication circuit unit, an input/output unit, a storage circuit unit, and a memory, wherein the processor is coupled to the communication circuit unit, the input/output unit, the storage circuit unit, and the memory, wherein the communication circuit unit is configured to connect to the network, wherein the projectors comprise a first projector and at least one second projector, the firmware update method comprising:
in response to a first input operation applied to a first input/output unit of the first projector, performing a first communication procedure by a first processor of the first projector, wherein the first communication procedure comprises a first communication circuit unit of the first projector broadcasting first data to each of the at least one second projector;
in response to receiving the first data, performing a second communication procedure via a second processor of each of the at least one second projector, wherein the second communication procedure comprises a second communication circuit unit of each of the at least one second projector broadcasting second data to other projectors among the projectors;
when the processor of each of the projectors determines that the first communication procedure and the second communication procedure are completed, determining whether there is an up-to-date firmware file in the storage circuit unit according to the first data and the second data via the processor of each of the projectors;
when each of at least one of the projectors has the up-to-date firmware file in the storage circuit unit, transmitting the up-to-date firmware file to corresponding at least one other projector among the projectors via the communication circuit unit of each of at least one of the projectors, wherein each of the corresponding at least one other projector does not have the up-to-date firmware file; and
after each of the corresponding at least one other projector receives the up-to-date firmware file, performing a firmware update based on the up-to-date firmware file by the processor of each of the corresponding at least one other projector.

12. A projector, comprising:
a processor;
a communication circuit unit;
an input/output unit; and
a memory, wherein the processor is coupled to the communication circuit unit, the input/output unit, and the memory,
wherein the communication circuit unit is configured to connect to a network,
wherein in response to a first input operation applied to the input/output unit, the processor performs a first communication procedure, wherein the first communication procedure comprises:
generating first data according to information of the projector, and setting an initiation mark in the first data to a first value by the processor;
broadcasting the first data using a first communication protocol through the communication circuit unit;
receiving at least one second data broadcasted by at least one other projector via the network using the first communication protocol through the communication circuit unit, and storing the at least one second data in the memory; and
performing an idle time counting procedure by the processor to count a continuous idle time of not receiving any broadcasted second data, wherein when the continuous idle time is greater than an idle time threshold, the processor determines that the first communication procedure has been completed,
wherein the processor determines whether the projector and the at least one other projector have an up-to-date firmware file according to the first data and the at least one second data.

13. A projector, comprising:
a processor;
a communication circuit unit; and
a memory, wherein the processor is coupled to the communication circuit unit and the memory,
wherein the communication circuit unit is configured to connect to a network,
wherein the processor identifies at least one master projector having an up-to-date firmware file and at least one of slave projector not having the up-to-date firmware file among a plurality of projectors connected to the network according to first data and at least one second data stored in the memory,
wherein in response to determining that the projector is one of the at least one master projector, the processor is configured to perform a firmware transmission procedure, comprising:
in response to determining that a number of the at least one master projector is not greater than one, establishing a data connection to a target slave projector among the at least one slave projector using a default communication protocol through the communication circuit unit;
in response to determining that the number of the at least one master projector is greater than one, grouping the at least one master projector and the at least one slave projector into a plurality of firmware transmission groups according to the number of the at least one master projector, an IP identification code of each of the at least one master projector, a number of the at least one slave projector, and an IP identification code of each of the at least one slave projector, and establishing a data connection to a target slave projector in a same firmware transmission group as the projector using the default communication protocol through the communication circuit unit, wherein the target slave projector is one of at least one slave projector in the same firmware transmission group as the projector;
after establishing the data connection to the target slave projector, sending a firmware update request to the target slave projector through the data connection;
transmitting the up-to-date firmware file to the target slave projector via the data connection according to a firmware update response received from the target slave projector; and
in response to receiving a firmware reception completion notification from the target slave projector, selecting a slave projector from the at least one slave projector in the same firmware transmission group as the projector as another target slave projector to establish another data connection using the default communication protocol, and sending another firmware update request via the another data connection to transmit the up-to-date firmware file to the another target slave projector via the another data connection according to another firmware update response received from the another target slave projector.
